(19) United States
(12) Patent Application Publication
(10) Pub. No.: US 2013/0058539 A1
(43) Pub. Date: Mar. 7, 2013

(54) METHOD AND A SYSTEM TO DETECT AND TO DETERMINE GEOMETRICAL, DIMENSIONAL AND POSITIONAL FEATURES OF PRODUCTS TRANSPORTED BY A CONTINUOUS CONVEYOR, PARTICULARLY OF RAW, ROUGHLY SHAPED, ROUGHED OR HALF-FINISHED STEEL PRODUCTS

(71) Applicants: Cristian Mori, Genova (IT); Marco Campodonico, Rapallo (GE) (IT)

(72) Inventors: Cristian Mori, Genova (IT); Marco Campodonico, Rapallo (GE) (IT)

(73) Assignee: TENOVA S.p.A, Milan (IT)

(21) Appl. No.: 13/637,463

(22) PCT Filed: Mar. 22, 2011
(86) PCT No.: PCT/IB11/00633

§ 371 Date: Nov. 19, 2012

(30) Foreign Application Priority Data
Mar. 26, 2010 (IT) MI2010A 000517

(51) Int. Cl. G06K 9/00

(52) U.S. Cl. 382/106

(57) ABSTRACT

A method to detect and to determine geometrical, dimensional and positional features of products (P) transported by a continuous conveyor (2), particularly of raw, roughly shaped, roughed or half-finished steel products, moving forwards with a transport speed lower or equal to a maximum transport speed (V), comprising the steps consisting of: acquiring (100), through at least an image acquisition device (3) placed crosswise to the forwarding direction (F) of a continuous conveyor and at a distance from it, at least a first series of successive images showing a same area across which runs the continuous conveyor (2), on which rests at least a product (P); identifying (101) in the first image series an initial image including the head end of the product (P) considered in respect to the forwarding direction (F); acquiring (102), through the image acquisition device (3), at least a second series of successive images showing the product moving forward along the forwarding direction (F), with an acquisition frequency so as to obtain, at the maximum transport speed (V), a partial overlapping of two successive images; selecting (103), in the initial image and in each image of the second series of successive images showing said product, a recognition area (A); estimating (104) the displacement vector of the recognition area (A), selected in the initial image and in each image of the second image series, between the image where it was selected and an image following the one where it was selected; identifying (105) among the images of the second series of successive images showing the product (P) a final image containing the tail end of the product considered in respect to the forwarding direction (F); processing (106) the estimated displacement vectors and/or the images of the product (P) acquired according to calculation and image processing algorithms to obtain at least a dimensional, geometrical or positional characteristic data of said product.

The present invention refers to a method and to a system to detect and to determine geometrical, dimensional and positional features of products transported by a continuous conveyor.

In particular, the present invention refers to a method and to a system to detect and to determine geometrical, dimensional and positional features of raw, roughly shaped, roughed or half-finished steel products of the type for example of billets, thick slabs, coils, plates and the like, transferred between different work stations of the respective production line by means of a continuous conveyor.

In the field of steel metallurgy, the production lines of various products, even large products such as for example thick slabs, billets, coils and the like, have been made automated and are always object of further automation.

Along such production lines the products are transferred from one work station to another by means of continuous conveyors of the type for example of roller belts or conveyor belts.

The management of the production lines and their correct operation require the monitoring of the flow of products between the different work stations and the “tracking” of each product being processed.

In particular, it is necessary to know different dimensional, geometrical and positional parameters of the products.

In particular, it is necessary to be able to determine the position of a certain product with respect to the longitudinal axis of the continuous conveyor or with respect to the inlet of a certain work station, so as to be able to identify possible misalignments, rotations or orientations of such a product that could lead to situations of malfunctioning or of danger, and so as to be able to actuate suitable correction operations.

Moreover, it is necessary for example to know the dimensions and/or the masses of the products directed towards a certain work station and their time of arrival at such a station, so as to be able to intervene on its management and be able to optimize the operation thereof.

Let us consider a station consisting of an oven for heat treatments: knowing the dimensions, the masses and the time of arrival of a product, makes it possible to determine the heat necessary for its treatment and to consequently adjust the operation of the oven.

Or again it is necessary to be able to detect the shape of the products being processed and/or their surface appearance so as to be able to identify possible manufacturing defects.

With particular reference to the steel metallurgy field, different types of systems are known which make it possible to detect the dimensions (length, height, width) and possibly the weight of the products being processed:
offline or online systems for detecting through contact;
offline optical-mechanical detection systems;
online detection systems through photocells and encoders,
online detection systems through laser scanning.

Offline systems for detecting through contact or of the optical-mechanical type are made up of devices equipped with feelers or optical devices for measuring the dimensions of the product and of sensors for detecting the weight of the product.

An offline optical-mechanical detection system is for example described in KR2000-0019784.

Such measuring devices, also due to the dimensions of the steel products being processed, have considerable bulk and weight and require suitable installation areas. Moreover, they have a complex structure and, in addition to frequent and costly maintenance operations, they need offline operations to be carried out.

Contact measuring systems have also been applied online. In JP-2004-283865 for example, a system is known for detecting through contact, which is inserted along the line for cutting a continuous casting coil so as to obtain thick slabs of a certain length.

Such measuring systems, indeed because they are applied directly to the line (continuous conveyor), lead to a complication of the structure and an increase of the bulk of the line itself.

Online detection systems with photocells and encoders are based upon the use of at least one photocell placed next to the continuous conveyor, of the roller conveyor type, to detect the start and the end of a product and of at least an encoder associated with a roller of the conveyor. With such systems it is possible to detect at least the length of the product, except for possible sliding or misalignment with respect to the continuous conveyor; they, thus provide measurements affected by errors and that are not precise.

In order to avoid such a problem and to reduce the measurement error it is necessary to adopt complex systems of photocells or sensors, arranged both along the opposite sides, and above and below the plane of the continuous conveyor, so as to be able to determine possible sliding and to identify possible misalignments of the products.

Systems of this type are described for example in KR2004-0040562 or in JP02-26210.

This last document describes a system that makes it possible to determine online, both the length, and the width of a slab being processed, considering also its possible misalignments with respect to the longitudinal axis of the continuous conveyor.

Such detection systems through photocells and encoders, in addition to providing measurements that are not, in any case, very accurate, require the installation of complex arrangements of photocells and sensors near to the continuous conveyors, where the photocells and the sensors are exposed to a dirty environment and to considerable risks of being damaged. Cleaning and maintenance operations are thus frequently required by such systems and are costly.

The online detection systems through laser scanning make it possible to detect the length or the width of a product for example with the use of two time of flight laser sensors. The measurement obtained is given by the width of the signal in anticoincidence between the emitted laser beam and its reflected fraction.

Since the scanning of the product, in length or width, occurs in a mechanical manner, it requires time and, sometimes, the slowness of the scanning does not make it possible to highlight possible misalignments between the longitudinal axis of the products and the forwarding direction along the line.

Laser scanning systems also exist which sample a single point of the product, when the conveyor and, therefore, the product is still.

The measurements carried out are also affected by errors that are proportional to the forwarding speed of the products along the line.

Finally, it is often impossible to find an arrangement of the lasers that makes it possible to scan and measure the different types of products that can be conveyed along one same line, whatever their dimensions in length and width may be.

Such drawbacks have at least partially been overcome with detection systems in which the entire product is hit, on one or more faces, with one or more fans of radiation emitted by one or more lasers and in which a camera records the radiation incident on the product to obtain an image that is then processed. One example of such a system is described in JP11-291008.

Such systems are however costly, bulky and must be installed on the conveyor line, limiting the possibilities of intervention on it, for example for maintenance operations.

Finally, interferometric laser systems are known that, exploiting the Doppler effect, consider the movement of the product along the line. These last systems are however extremely costly and complex and therefore have limited application.

The purpose of the present invention is that of providing a method to detect and to determine geometrical, dimensional and positional features of products transported by a continuous conveyor, particularly of raw, roughly shaped, roughed or half-finished steel products, which makes it possible to avoid the drawbacks of known systems described above.

In particular, one purpose of the present invention is that of providing a method that makes it possible to detect the dimensions of a product transported by a continuous conveyor along a production line or machining line, particularly a raw, roughly shaped, roughed or half-finished steel product, while it is moving forward along the line itself, with sufficient precision and irrespective of possible sliding and/or accelerations of the product with respect to the continuous conveyor and of the dimensions of the product itself.

A further purpose of the present invention is that of providing a method that makes it possible to also detect the position and/or possible misalignments of the product with respect to the longitudinal axis of the continuous conveyor, i.e. with respect to the forwarding direction along the production line or machining line.

Another purpose of the present invention is that of providing a method that makes it possible to identify and recognize a product moving forward along a production line or machining line and to track its position along such a line.

Another purpose of the present invention is that of making a system to detect and to determine geometrical, dimensional and positional features of products transported by a continuous conveyor, particularly of raw, roughly shaped, roughed or half-finished steel products, that makes it possible to implement such a method with devices with low cost and that are readily available.

These purposes according to the present invention are achieved by making a method and a system to detect and to determine geometrical, dimensional and positional features of products transported by a continuous conveyor, particularly of raw, roughly shaped, roughed or half-finished steel products, as outlined in the independent claims.

Further characteristics of the method and of a system to detect and to determine geometrical, dimensional and positional features of products transported by a continuous conveyor, particularly of raw, roughly shaped, roughed or half-finished steel products, are foreseen in the dependent claims.

The characteristics and the advantages of a method and of a system to detect and to determine geometrical, dimensional and positional features of products transported by a continuous conveyor, particularly of raw, roughly shaped, roughed or half-finished steel products, according to the invention shall become clearer from the following description, given as an example and not for limiting purposes, with reference to the attached schematic drawings, in which:

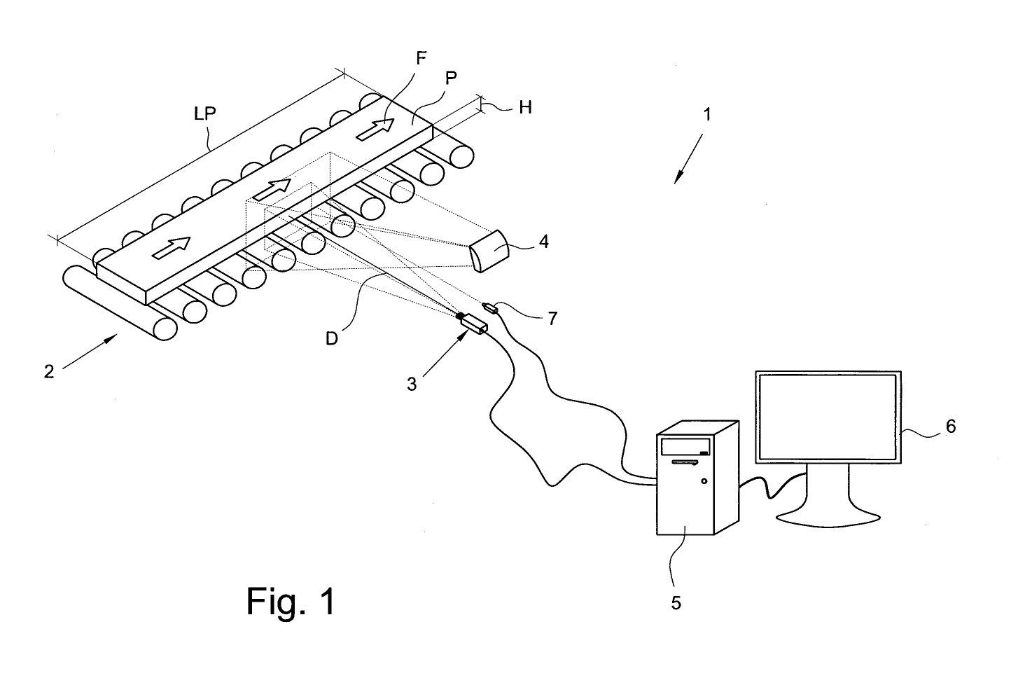

FIG. 1 is a diagram representing a system according to the present invention;

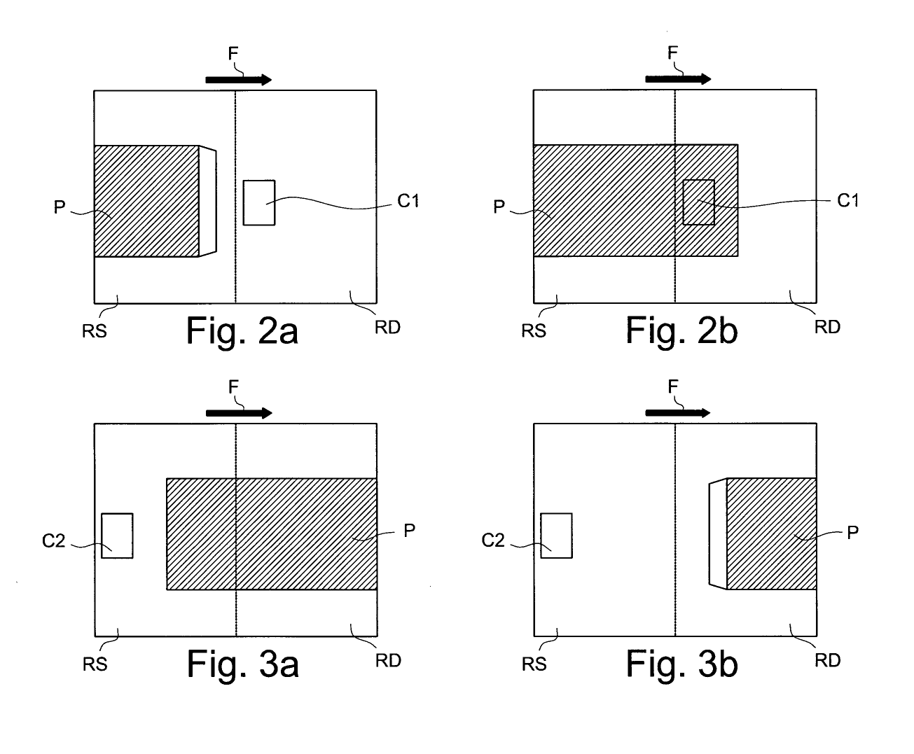

FIGS. 2a and 2b schematically show two successive images of the first image series acquired according to the method of the present invention, of which the second is identified as the initial image of the product;

FIGS. 3a and 3b schematically show two successive images of the second image series acquired according to the method of the present invention, of which the first is identified as the final image of the product;

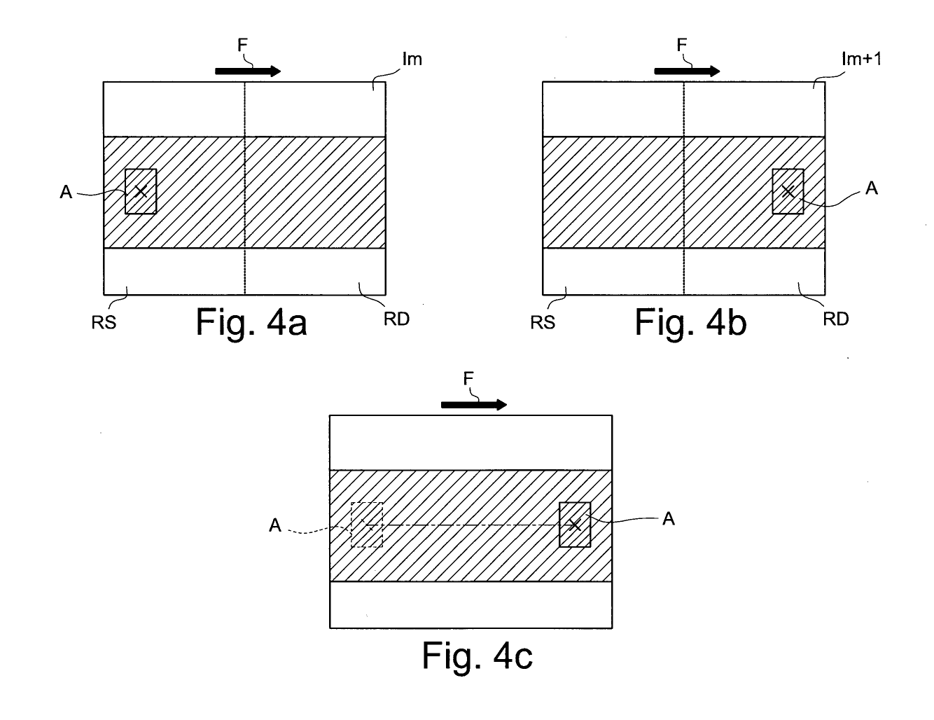

FIGS. 4a, 4b and 4c schematically show two successive images of the second image series acquired according to the method of the present invention and the method for rating the displacement vector of the recognition area selected in the first of them with respect to the second;

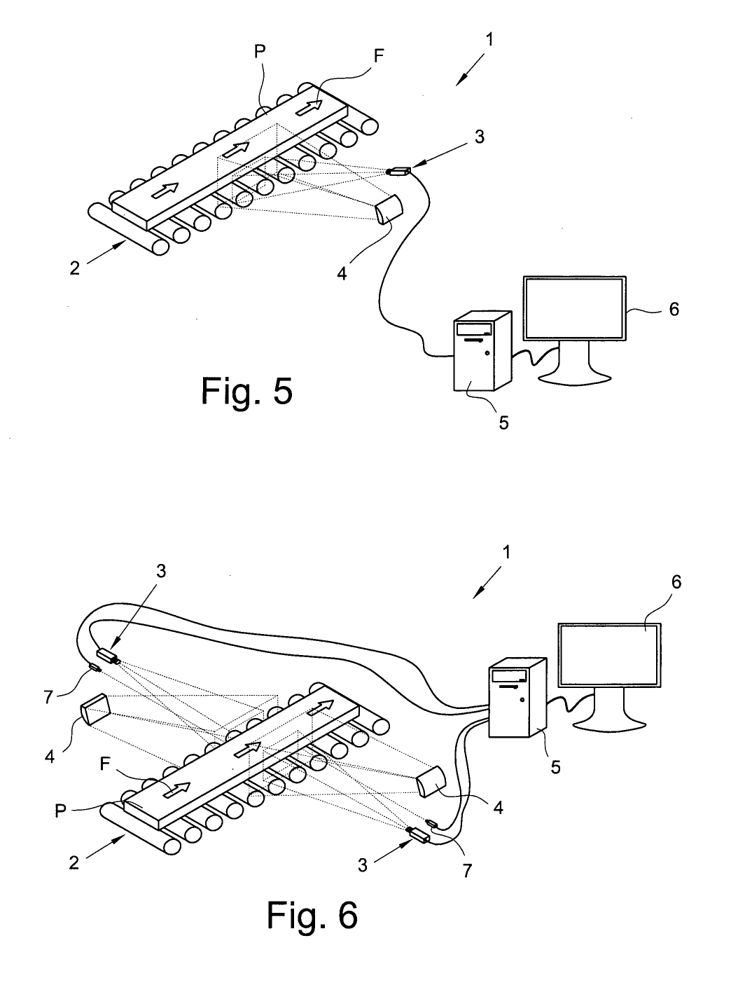

FIGS. 5 to 8 schematically show different configurations of the system according to the present invention;

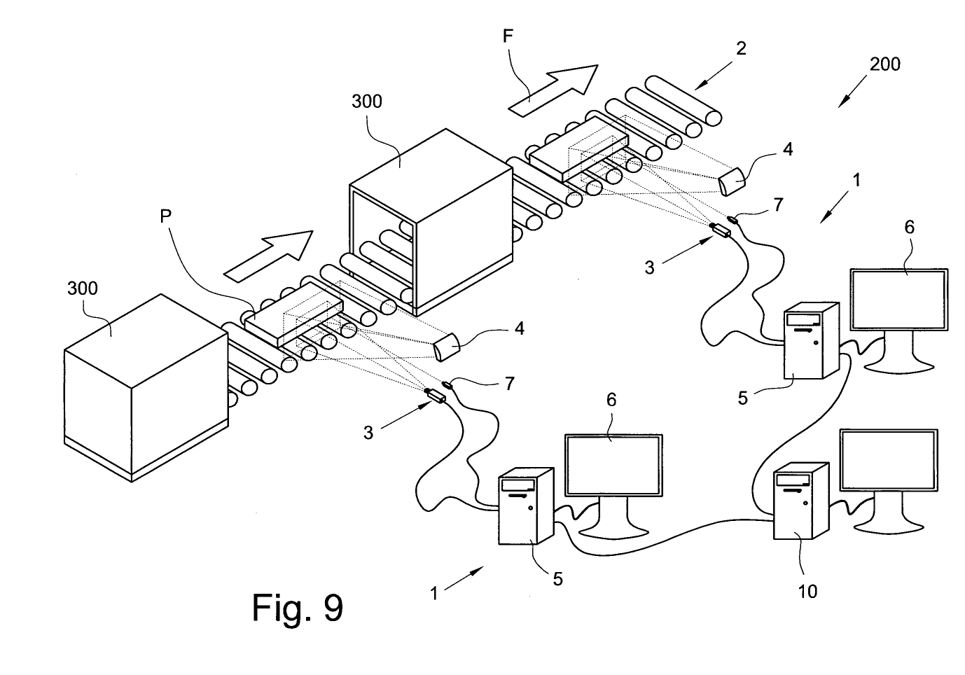

FIG. 9 schematically shows a device for monitoring the flow of products transported by a continuous conveyor between different stations of a production or machining line, comprising a series of systems according to the present invention;

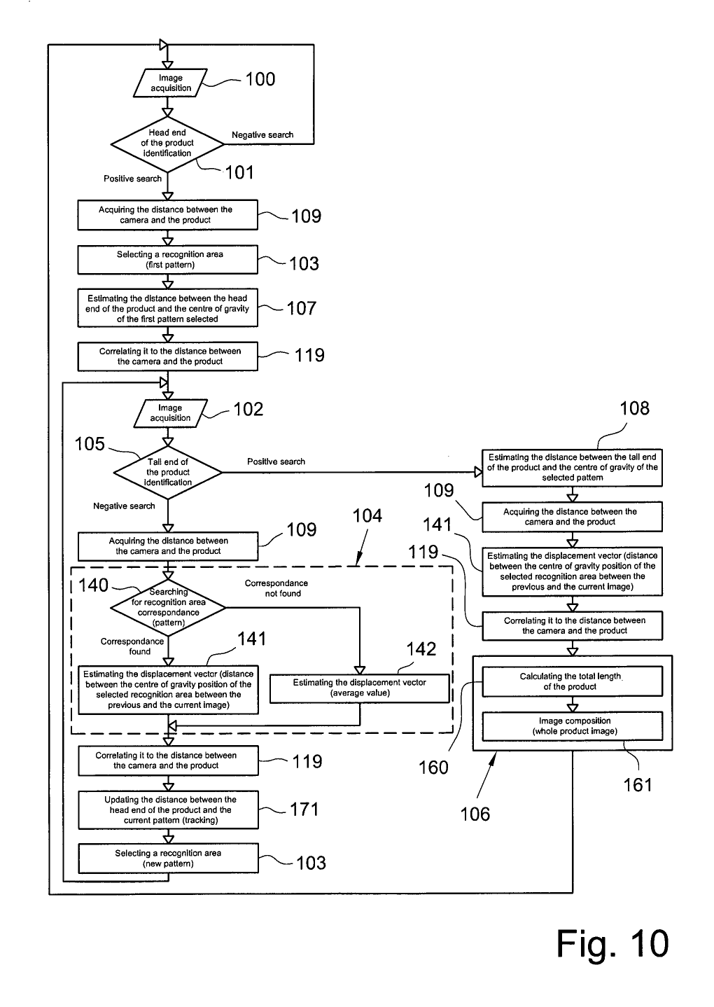

FIG. 10 is a flow chart representative of the method according to the present invention.

With reference to FIG. 1, a system to detect and to determine geometrical, dimensional and positional features of products transported by a continuous conveyor, particularly of raw, roughly shaped, roughed or half-finished steel products is wholly indicated with reference numeral 1.

The system 1 can be applied to any continuous conveyor 2 that transports products P along a forwarding direction F of a machining or production line, transferring them between different stations of the line itself.

The products P proceed along the forwarding direction F with a speed, that is even not known and not constant, but in any case, that is less than or equal to a maximum transport speed.

In the attached figures, the continuous conveyor 2 is of the roller conveyor type; it could also have a different structure, for example a conveyor belt.

The system 1 comprises at least an image acquisition device consisting of a camera 3 that is placed crosswise to the forwarding direction F and at a defined distance from the continuous conveyor 2.

The camera 3 is associated to a lighting device made up of a spot light 4 or another device, such as for example a strobe in step with the camera 3 or an invisible light (UV or IR) emitter, which hits the product P with a light beam such as to ensure a level of illumination necessary and sufficient for recording, preventing prolonged exposure time from negatively affecting the quality of the recorded images.

As shall become clearer in the following description, the camera 3 can be arranged with its axis on a plane vertical and orthogonal to the forwarding direction F and oriented with an angle α in respect to the vertical 0°≦α≦90° as long as the face of the product P in the frame is recorded for the entire width H crosswise with respect to the forwarding direction F.

The system 1, moreover, can comprise many cameras 3, each associated with a respective spot light 4, arranged so as to frame a different face of the product P with same or different camera angles.

With particular reference to FIG. 1, the system 1 comprises a camera 3 arranged with its axis with an angle α of 90° in respect to the vertical.

The camera 3 is associated to a processing unit 5 that comprises software means through which the images it has recorded are processed so as to detect and identify the product P, being able to track its passing by, and/or to determine at least one piece of geometrical, dimensional or positional data characteristic of the product P itself.

For such a purpose, the software means implement the method to detect and to determine geometrical, dimensional and positional features of products transported by a continuous conveyor, particularly of raw, roughly shaped, roughed or half-finished steel products, according to the present invention and described later on in the description.

The processing unit 5, moreover, is connected, through a suitable interface, to displaying means 6 and/or to at least a second central processing unit, not shown, so as to provide the data obtained for a further processing thereof, for example in the case in which it is necessary to “track” the forward direction of the product P along the production line, to intervene on the operation of the continuous conveyor 2 so as to modify or correct the forward direction of the product P or to intervene on the operation of a work station placed along the line.

In a preferred embodiment, moreover, the system 1 also comprises a device for detecting the distance between the camera 3 and the continuous conveyor 2 or the product P located on it, said distance detecting device being associated with the same processing unit 5.

Such a distance detecting device can be made up of a laser sensor 7 of the time of flight type.

Both the camera 3, and the spot light 4, as well as the possible laser sensor 7 are of the known type and are commonly available on the market and, when they are considered by themselves, do not form object of the present invention, therefore, they shall not be described any further.

The operation of the system 1 that implements the method according to the present invention is as follows.

The camera 3, placed in a fixed location with respect to the continuous conveyor 2 and at a defined distance from it, frames a same area across which runs the continuous conveyor 2 on which the product P rests.

Of such an area a first series of successive images is acquired (acquiring step 100).

When the product P transits in the area framed by the camera 3, among the images of such a first image series an initial image is identified including the head end of the product P, considered in respect to the forwarding direction F. Such a step is indicated as the identification step of the start of the product or of the head end of the product P (step 101). Until such an initial image has been identified, the system continues to acquire images of the first image series, i.e. images of the area across which runs the continuous conveyor 2.

From the moment in which the start of the product P has been identified, i.e. from the identification of the initial image, the camera 3 acquires at least a second series of successive images showing the product P moving forward along the forwarding direction F (image acquiring step 102).

The acquiring occurs with a frequency so as to obtain, at the maximum transport speed possible V, a partial overlapping of two successive images.

Such a condition is expressed by the following formula:

V*T<(1/n)*L

Where V is indeed the maximum transport speed possible for the products P, T is the time that passes between the acquiring of two successive images, L is the length, considered along the forwarding direction F, of each image and n≧2, so that two successive images overlap for at least a portion equal to L/n. Preferably n=2 and each image is considered divided by a midplane in two successive sections with equal dimensions, respectively indicated as the right section RD and the left section RS with respect to the forwarding direction F. In the following description, the forwarding direction F is considered, purely as an example, from left to right.

From the initial image and for each image of the second image series acquired, i.e. for each image of the product P acquired, the system 1 selects in it a recognition area A or recognition pattern (selecting step of a recognition area (pattern) 103).

By recognition area or recognition pattern we mean to indicate a portion of the image of the product that can be identified and recognized with respect to the remaining portion of the image. It is therefore necessary for the surface texture of the face of the product P recorded by the camera 3 to not be even or repetitive or, if repetitive, it must have repetitions that are at a distance from one another that is greater than the overall portion of product recorded in two successive images.

Therefore, the method according to the invention can be applied to all those products that satisfy such a condition.

Once a recognition area or pattern A in an image of the product P has been selected, the system estimates the displacement vector of such a recognition area or pattern A between the image of the product P where it was selected and an image following the one where it was selected (step 104).

This occurs until, between the images of the second image series, i.e. between the images acquired showing the product P, the final image is identified, i.e. an image containing the tail end of the product P considered in respect to the forwarding direction F (product end or tail end of the product 105 identification step).

The system 1 finally processes the estimated displacement vectors and/or the images of the product P acquired according to calculation and image processing algorithms so as to obtain at least a dimensional, geometrical or positional data feature of the product P (processing step 106).

Such a processing step 106 particularly comprises a calculation step, on the base of the estimated displacement vectors, of the overall length LP of the product P (step 160), and a joining step, on the base of the estimated displacement vectors, of the images of the product P, comprised between and comprising the initial image and the final image, so as to form a unique image identifying the product P, or rather its face recorded by the camera 3 (step 161).

The system 1 also comprises a step consisting of estimating the distance of the head end of the product P both respect to the recognition area or pattern A selected both in the initial image (first pattern selected—step 107), and in each image belonging to the second series of successive images showing the product P up to its final image (tracking step 171).

This makes it possible to obtain and keep track of the position of the head end of the product P, while it advances along the forwarding direction F.

In order to obtain a complete picture of the product P, the system 1 also foresees a step of estimating the distance of the tail end of the product P with respect to the recognition area selected in the image of the product preceding the final image (step 108).

For the processing of the displacement vectors in metric units for the calculation of dimensional, geometric or positional parameters of the product P, the system 1 also comprises, for each image of the product P acquired, including the initial image and its final image, a step consisting of acquiring and associating to such an image a positional and/or dimensional reference parameter on the base of which it processes the images and/or the displacement vectors related to them. In a preferred embodiment, to each image of the acquired product P is associated the distance D between the camera 3 and the portion of product P recorded in it (acquiring step of the distance between product and camera 109).

The distance value D thus acquired and associated with each image of the product is then correlated to the estimation of the displacement vector associated with such an image so as to be able to estimate the value in metric units (correlation step 119).

In a preferred embodiment, the system 1 also comprises a step consisting of associating to the initial image and to each image of the product acquired at least a time reference parameter selected between an absolute time reference parameter (referring to the camera 3) and a relative time reference parameter (referring to the continuous conveyor). On the basis of such a time parameter, the displacement vectors, the distance of the head end from the current image and the distance of the tail end of the product from its preceding image are then processed to determine the motion law of the product itself, being for example able to check for possible sliding or accelerations with respect to the continuous conveyor 2.

It should be understood that the aforementioned steps can be carried out successively and in real time with the acquisition of the images themselves.

It is not excluded however for the images to be first acquired and then processed in a moment that is delayed with respect to their acquisition.

Hereafter, some of the steps mentioned above are described in greater detail.

As indicated above, when a product P is not transiting through the area framed by the camera 3, the latter acquires a series of successive images of such an area which are stored (first image series acquiring step 100).

In such images the system 1 identifies two control portions that are selected based upon the environment characteristics of the place in which the system operates and that are typically: a portion C1 in the right section RD and a portion C2 in the left section RS, where right and left refer to the forwarding direction F. The system 1 creates and updates a respective estimate function of the parameters of the image, typically a histogram function, of such control portions C1 and C2.

Such control portions C1 and C2 are used for identifying the initial image and the final image of the product P (steps 101 and 105).

FIGS. 2a and 2b schematically show the identifying step of the initial image (step 101).

In the described embodiment, the control portion C1 is in the right section RD of the image, since until the head end of the product P occupies only the left section RS also its front face is visible. When the head end occupies the control portion C1, the control function of the parameters (histogram) associated to it undergoes a substantial variation. On the basis of such a variation the system 1 identifies the initial image of the product P.

In a completely analogous manner, the identification of the final image of the product, schematised in FIGS. 3a and 3b occurs. In such a case, the control portion C2 is in the left section RS, to avoid recording also the rear side of the product, condition which happens when its tail end occupies only the right section RD of the image. In such a case, when there is no product P, the control function of the parameters (histogram) associated with the control portion C2 returns similar to that initially acquired (acquiring step 100), when this happens, the system 1 recognizes the tail end of the product and therefore identifies its final image.

In an alternative embodiment, the head end and the tail end of the product P can be detected by sensors of the type with photocells suitably arranged with respect to the camera 3. In such a case the first image series acquired could consist of a single image coinciding with the initial image of the product P.

It is also possible to foresee a system combining the two previous ones.

The selection step in each image of the product P acquired, including its initial image, of a recognition area or pattern A (step 103) consists in identifying in the left section RS of such an image, or in another suitable portion of the image, an area or portion that has an appearance that can be identified and recognized with respect to the remaining portion of the image.

In order for such a selection to be possible it is necessary for the images of the product P acquired to have a sufficient level of definition.

In a preferred embodiment, in order to obtain a good definition level it is necessary to impose that the displacement of the product P during the time of maximum exposure (t) of the sensitive element of the camera 3 (for example a CCD charge-coupled-device) is lower than the equivalent of a pixel, needing the following condition to be satisfied:

t<(d*D)/(V*f)

Where t is the time of maximum exposure of the sensitive element, d is the size of a pixel, f is the focal distance of the lens, D is the distance between the camera 3 and the product P, V is the maximum forward speed of the product P, with D>>f.

For example, with a digital camera with pixel d=15 μm and focal f=50 mm placed at D=2 m from the product P which moves forwards at a speed V=0.5 m/s, a maximum time of exposure t=1.2 thousandths of a second, is obtained.

Of course, different selections are possible.

Usefully, the focusing of the optics connected to the camera 3 is adjusted in a continuous manner by the processing unit 5, so as to obtain greater detail in the images acquired.

Once a recognition area or pattern A has been selected in the left section RS of the initial image, the system calculates (step 107) the distance between the head end and the centre of gravity of the recognition area or pattern A thus selected (first pattern selected). The evaluation of such a distance and its tracking (step 171) for each successive image of the product acquired makes it possible to keep track of the head end of the product P.

From the initial image and for each successive image up to the final image, the displacement vector of the recognition area or pattern A selected (step 104) is evaluated.

Such an estimating step (step 104) comprises the steps that, considering as forwarding direction F that going from left to right, consist of:
searching the recognition area or pattern A selected in an image (Im) of the product, selected particularly in the left section RS of such an image (Im) (FIG. 4a), in a following image thereof, particularly of the right section RD of the image of the product immediately following it (Im+1) (step 140),
if the search is positive, i.e. the system has tracked in the right section RD of the image (Im+1) the recognition area or pattern A selected in the preceding image (Im), calculating the value of the distance between the centre of gravity position of the recognition area or pattern A in the image where it was selected (Im) and in the following image thereof (Im+1) (FIG. 4c) and attributing to the displacement vector the value of the distance thus calculated (step 141).

If the search is negative, it is carried out on a successive image (Im+2) and if also such a search is negative, then the system selects a different recognition area or pattern in the source image (Im) and repeats the searching step relative to such a different recognition area or pattern selected.

In the case in which also the repeated search step is negative, then a mean value of the displacement vectors previously estimated is calculated to be attributed to the current displacement vector (step 142).

Such a last estimation can be improved at a later time, i.e. once all the images have been acquired and the relative displacement vectors have been calculated, considering a mean value of the displacement vectors of the images that precede and follow that in which the correspondence search is negative.

On the basis of the displacement vector thus estimated the distance of the head end of the product P (step 171) is updated.

The system 1 then continues by selecting a new recognition area or pattern in the left section RS of the image (Im+1) and repeats the steps described above.

The system 1 estimates the values of the displacement vectors and of the position of the head end in pixels; in order to convert them in metric units it is necessary to correlate (step 119) the values thus estimated to a dimensional reference parameter, for example to the distance between camera 3 and product P.

For such a purpose, as indicated above, the system 1 provides for acquiring and associating to each image of the product P the value of the distance D between the camera 3 and the portion of product P recorded in such an image (step 109).

Such a step can comprise different steps according to whether the distance D is known beforehand or not or whether it is constant or not along the entire longitudinal development of the product P.

If the distance D between the camera 3 and the product P is constant for its whole longitudinal development comprised between the head end and the tail end and has a known value, then to each image such a known value is associated.

If the distance D between the camera 3 and the product P is not known or is not constant for its whole development comprised between the head end and the tail end, different alternatives can be actuated:
acquiring, for each portion of product P recorded by the camera 3, the value of the distance D from a distance detector made up for example of a time of flight laser sensor 7 and associating the acquired value with the relative image of the product, or
extrapolating, for the initial image and for each successive image of the product, the value of the distance D from known dimensional reference parameters or elements and recorded in the images of the product itself and associating the extracted value with the relative image.

As a reference parameter from which to extrapolate the distance D, the height H of the product P can be used, if it is known and is constant along the entire longitudinal development of the product P.

If also the height H is not known or is not constant, it is possible to apply near to the head and tail ends of the product a respective reference element, of the label type, with known sizes and, for each image of the product, extrapolate the value of the distance D from the images of such two reference labels recorded respectively in the initial and final images of the product. The use of such two known reference labels makes it possible to detect also possible inclinations of the product P with respect to the longitudinal axis of the continuous conveyor 2.

Alternatively, it is possible to direct the camera so as to record, in each image, a known portion of the continuous conveyor 2, and, for each image of the product, extrapolate the value of the distance D from the known portion of the continuous conveyor 2 recorded in it.

As can be easily understood by men skilled in the art, the images of the product P acquired and the data gathered from them (length of the product, position of the head end of the product, distance between product and camera, etc.) can be further processed to find further geometrical, dimensional or positional data features of the product P.

For example, by correlating the images of the product P to a relative or absolute time reference parameter, it is possible to find the motion law of the product P and verify possible sliding or accelerations with respect to the continuous conveyor 2, so as to be able to possibly intervene on the operation of the latter.

From the images acquired, by arranging the camera 3 inclined by a non-zero angle with respect to a horizontal plane, so as to record a portion of the continuous conveyor, it is possible to find data concerning the position of the longitudinal axis of the product P with respect to the crosswise direction of the continuous conveyor 2 or to its possible inclinations just like data relative to the shape profile of the surface of the face recorded by the camera, detecting for example concave or convex shapes. These last data can be used to intervene on the production line, for example to correct the position of the product P in inlet to a work station placed along the line.

The same applies in the case in which for each image of the product P also the distance D between the camera 3 and the portion of product P recorded in it is acquired, for example through a laser sensor 7.

As already indicated, the system 1 can comprise several cameras 3, applying the steps described above to the images acquired by each camera. In such a case it is possible to compose the images acquired by two or more cameras 3, arranged so as to frame different faces of the product P, so as to obtain an overall stereoscopic image of the entire product P.

In figures from 5 to 8 different embodiments of the system 1 are shown. In FIG. 5 the system 1 comprises a single camera 3 placed at an angle α that is non-zero with respect to the horizontal plane containing the continuous conveyor 2, in such a case the portion of continuous conveyor 2 recorded in each image can be used as a reference for the acquisition of the distance D between the camera 3 and product P without it being necessary to provide a distance detector.

In FIG. 6 a system 1 is shown comprising two cameras 3 arranged with their axis at 90° with respect to the vertical, arranged, aligned with one another, at opposite sides of the continuous conveyor 2 so as to frame two opposite faces of the product P.

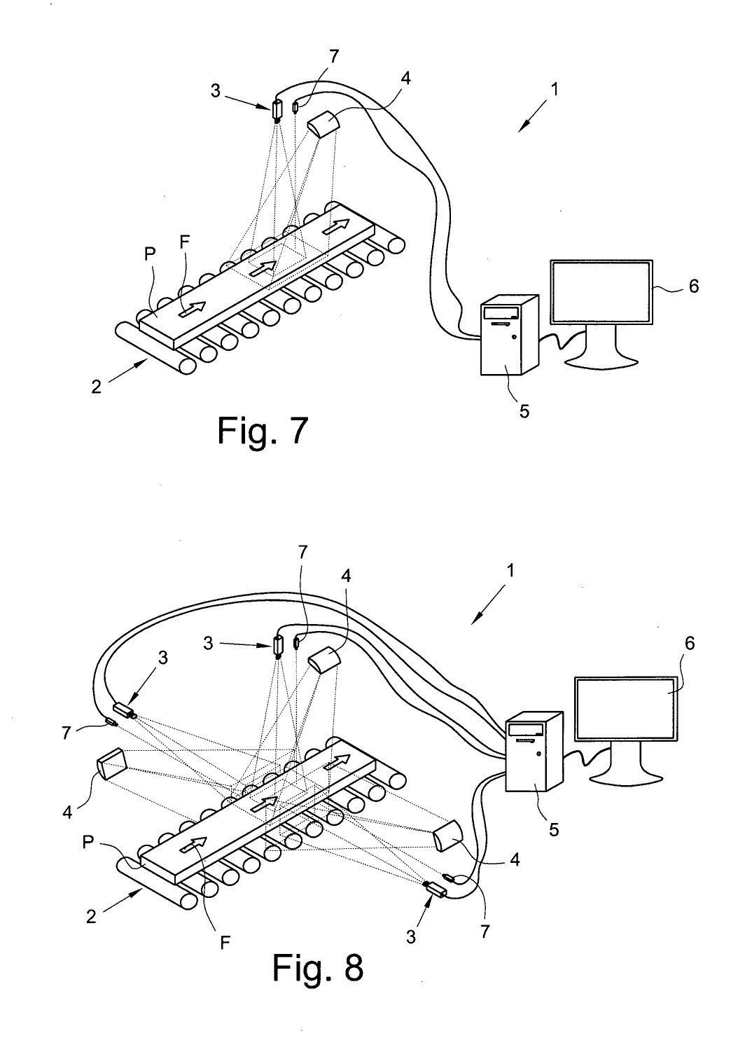

FIG. 7 shows a system 1 comprising a single camera 3 placed with its axis on the vertical so as to frame the upper face of the product P being able to easily detect possible misalignments thereof with respect to the longitudinal axis of the continuous conveyor 2.

FIG. 8 shows a system 1 comprising three cameras 3 placed at 90° with respect to one another.

Finally, FIG. 9 shows a device 200 comprising a series of systems 1 applied in different locations along a production or machining line of the products P in which a continuous conveyor 2 transfers the products P between different work stations 300. In such a case the systems 1 can be connected to a central control unit 10 which oversees the management of the line itself. It is therefore possible to identify and recognize a product P in different locations through which it passes, keep track of its movement forwards along the line, determine in each location the position it has taken on etc.

From the description carried out and by the attached figures the characteristics of the method and of the system object of the present invention are clear, just as the relative advantages are also clear.

In particular, the system and the method according to the present invention make it possible to determine dimensional, geometrical and positional data of any product P while it advances along a forwarding direction defined by a continuous conveyor, particularly while it advances along a production line.

The sole condition for the system and the method according to the invention to be able to be applied is that the product P must have a surface texture that is not even or not repetitive or, if it is repetitive, it has repetitions at a distance from one another that is greater than the overall portion of product recorded in two successive images.

Therefore, the system and the method according to the invention can be applied particularly to raw, roughly shaped, roughed or half-finished steel products, of the type of thick slabs, billets, coils and the like and in general to all products that satisfy the condition indicated above, such as, for example, products made from marble or wood.

The system and the method according to the invention make it possible to determine particularly dimensional data, specifically the overall length of a product, whereas the latter proceeds along a production or machining line by providing an accurate and measurement irrespective of possible sliding or acceleration of the product itself with respect to the continuous conveyor on which it rests and irrespective of the dimensions of the product itself.

The system and the method according to the present invention also make it possible to identify and recognize a product along a production line, keeping track of its position and detecting its possible misalignments with respect to the longitudinal axis of the continuous conveyor, so as to be able to provide data useful to make suitable interventions on the operation of the continuous conveyor and/or of the work stations connected by it, for example to align the product with respect to the inlet into a work station.

Such purposes are moreover achieved with a system which uses known devices, easily found and with low costs and can be applied to existing production lines without it being necessary to carry out particular installation interventions.

The system according to the present invention, moreover, is placed alongside and at a distance from the continuous conveyor, leaving it practically free to access for any intervention.

The system and the method thus conceived can undergo numerous modifications and variants, all covered by the invention; moreover, all the details can be replaced by technically equivalent elements. In practice the materials used, as well as the sizes, can be any according to the technical requirements.

1. A method to detect and to determine geometrical, dimensional and positional features of products (P) transported by a continuous conveyor (2), particularly of raw, roughly shaped, roughed or half-finished steel products, moving forward with a transport speed lower or equal to a maximum transport speed (V), comprising the steps consisting of:
acquiring (100), through at least an image acquisition device (3) placed crosswise to the forwarding speed (F) of a continuous conveyor and at a distance from it, at least a first series of successive images showing a same area across which runs said continuous conveyor (2), on which rests at least a product (P);
identifying (101) in said first image series an initial image including the head end of said product (P) considered in respect to said forwarding direction (F);
acquiring (102), through said image acquisition device (3), at least a second series of successive images showing said product moving forward along said forwarding direction (F), with an acquisition frequency so as to obtain, at said maximum transport speed (V), a partial overlapping of two successive images;
selecting (103), in said initial image and in each image of said second series of successive images showing said product, a recognition area (A);
estimating (104) the displacement vector of the recognition area (A), selected in said initial image and in each image of said second image series, between the image where it was selected and an image following the one where it was selected;
identifying (105) among the images of said second successive image series showing said product (P) a final image containing the tail end of said product considered in respect to said forwarding direction (F);
processing (106) the estimated displacement vectors and/or the acquired images of said product (P) according to calculation and image processing algorithms to obtain at least a dimensional, geometrical or positional characteristic data of said product.

2. Method according to claim 1, comprising also a step consisting in joining (161), on the base of the estimated displacement vectors, the images of said product (P) comprised between and comprising said initial image and said final image to form a unique image identifying said product.

3. Method according to claims 1 or 2, comprising also the step (107; 171) consisting of estimating the distance between said product (P) head end and the recognition area (A) selected in said initial image and in each image of said second successive image series showing said product (P) up to said final image so as to be able to track the position of said head end.

4. Method according to claim 3, also comprising the step (108) consisting of estimating the distance between said product (P) tail end and the recognition area (A) selected in the image of said product preceding said final image.

5. Method according to one or more of the preceding claims, also comprising the step (109) consisting of acquiring and associating to said initial image and to each image of said second image series at least one positional and/or dimensional reference parameter on the base of which to process said images and/or displacement vectors related to them.

6. Method according to claim 5, wherein said dimensional reference parameter consists in the distance (D) between said image acquisition device (3) and the portion of said product recorded in the corresponding image.

7. Method according to claim 6, wherein said step (109) of acquiring and associating to said initial image and each image of said second image series at least a dimensional reference parameter, comprises the steps consisting of:
if the distance (D) between said image acquisition device and said product is constant for the whole development of said product comprised between said head and tail ends and has a known value, associating to said initial image and to each image of said second image series said known value,
if the distance (D) between said image acquisition device and said product is not known or is not constant for the whole development of said product comprised between said head and tail ends, thus
acquiring, for each portion of said product recorded by the image acquisition device (3), the value of said distance from a distance detector and associating the acquired value with the relative image of said product, or
extrapolating, for said initial image and for each image of said second image series, the value of said distance from parameters or dimensional reference elements known and recorded in the images of said product and associating the extracted value to the relative image.

8. Method according to one or more of the claims from 3 to 7, also comprising the steps consisting of:
associating to said initial image and to each image of the second image series at least a time reference parameter selected between an absolute time reference parameter and a time reference parameter relative to said continuous conveyor,
processing of said displacement vectors and said distances on the basis of said time reference parameter to determine the motion law of said product.

9. Method according to one or more of the preceding claims, wherein said estimate stage (104) of said displacement vector comprises the steps consisting of:
searching (140) the recognition area (A), selected in said initial image or in an image of said second image series, in an following image thereof,
if the search is positive, estimating (141) the value of the distance between the centre of gravity position of said recognition area (A) in the image where said recognition area (A) was selected and in the following image and attributing to the displacement vector the distance value thus calculated,
if the search is negative, selecting a different recognition area in the source image and repeating the search step,
if the repeated search step is negative, calculating (142) a mean value of the displacement vectors previously estimated and attributing to the current displacement vector the mean value thus calculated.

10. Method according to one or more of the preceding claims, wherein the identification steps of said initial and final images comprise the step consisting of detecting a variation of a control function of parameters of respective reference portions (C1, C2) selected in the images of said first image series showing said area across which runs said continuous conveyor (2).

11. Method according to one or more of the preceding claims, wherein said dimensional characteristics data is the length (LP) of said product.

12. Method according to one or more of the preceding claims, wherein said steps take place in real time with the acquisition of said successive images of said first series and of said second series.

13. Method according to one or more of the preceding claims, wherein said image acquisition device is placed with its axis on a plane, vertical and orthogonal to said forwarding direction (F), and that is oriented with an angle α in respect to the vertical 0°≦α≦90°.

14. Method according to claim 13, applied to the acquired images from at least two of said image acquisition devices (3) arranged with their axes oriented according to different angles α so as to record at least two faces, contiguous or opposite, of said product.

15. Method according to claim 14, also comprising the step consisting of joining the images of said product acquired by said at least two image acquisition devices (3) in a stereoscopic image of said product.

16. Method according to one or more of the preceding claims, wherein said image acquisition device (3) consists of a camera.

17. A system (1) to detect and to determine geometrical, dimensional and positional features of products (P) transported by a continuous conveyor (2), particularly of raw, roughly shaped, roughed or half-finished steel products, moving forward with a transport speed lower or equal to a maximum transport speed (V), comprising at least an image acquisition device (3) placed crosswise to the forwarding speed of a continuous conveyor (2) and at a defined distance from said continuous conveyor and that is associated to a processing unit (5) able to implement a method according to one or more of the claims from 1 to 16.

18. System (1) according to claim 17, also comprising a lighting device (4) of said continuous conveyor (2) associated to said image acquisition device (3).

19. System (1) according to claim 17 or 18, also comprising at least a device (7) to detect the distance between said image acquisition device (3) and said continuous conveyor (2) or a product (P) located on it, wherein said distance detecting device is associated to said processing unit (5).

20. System (1) according to one or more of the claims from 17 to 19, wherein said image acquisition device (3) is placed with its own axis on a plane vertical and orthogonal to said forwarding direction and oriented with an angle αcompared with the vertical of 0°≦α≦90°.

21. System (1) according to claim 20, comprising at least two said image acquisition devices (3) placed with their axes oriented according to different angles so as to record at least two faces, contiguous or opposite, of said product (P).

22. System (1) according to one or more of the claims from 17 to 21, comprising displaying means (6) interfaced with said processing unit (5).

23. System (1) according to one or more of the claims from 17 to 22, wherein said image acquisition device (3) consists of a camera.

24. A device (200) for monitoring the flow of products transported by an continuous conveyor (2) between different stations (300) of a production or manufacturing line, comprising two or more systems (1) according to one or more claims from 17 to 23, placed along said continuous conveyor (2) and whose processing units (5) are interfaced to a central processing unit (10).
